(19) United States
(12) Patent Application Publication
(10) Pub. No.: US 2007/0098181 A1
(43) Pub. Date: May 3, 2007

(54) Signal processing apparatus and method

(75) Inventors: Masayoshi Noguchi, Chiba (JP); Gen Ichimura, Tokyo (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/585,641

(22) Filed: Oct. 24, 2006

(30) Foreign Application Priority Data
Nov. 2, 2005 (JP) JP 2005-318996

(51) Int. Cl. H04R 5/00; H04R 1/40

(52) U.S. Cl. 381/17; 381/97

(57) ABSTRACT

A signal processing apparatus includes a first band-dividing unit that divides a first-channel sound signal of two-channel sound signals into signals of a plurality of frequency bands; a second band-dividing unit that divides a second-channel sound signal of the two-channel sound signals into signals of a plurality of frequency bands; a plurality of main-component extracting units that each receive, from among the signals of the plurality of frequency bands output from the first band-dividing unit and the signals of the plurality of frequency bands output from the second band-dividing unit, signals of the same frequency band, each of the plurality of main-component extracting units being provided in association with a corresponding frequency band; and a synthesizing unit that synthesizes a plurality of outputs acquired from the plurality of main-component extracting units to generate a main signal.

### CROSS REFERENCES TO RELATED APPLICATIONS

The present invention contains subject matter related to Japanese Patent Application JP 2005-318996 filed in the Japanese Patent Office on Nov. 2, 2005, the entire contents of which are incorporated herein by reference.

### BACKGROUND OF THE INVENTION

1. Field of the Invention

The present invention relates to a signal processing apparatus and a signal processing method that generate, from left-channel and right-channel stereo signals, a component close to a center localization position and/or a background sound component in which the component close to the center localization position is suppressed.

2. Description of the Related Art

In general, as a method for separately extracting, from left-channel and right-channel stereo signals, a signal corresponding to sound at a center localization position (hereinafter, referred to as center sound) and a signal corresponding to residual sound (hereinafter, referred to as background sound), a method for acquiring a center sound signal, which is represented as the sum L+R of a left-channel sound signal L and a right-channel sound signal R, and for separating a residual sound signal, which is represented as the difference L-R, from the center sound signal has been widely used.

Such a method is described, for example, in Japanese Unexamined Patent Application Publication No. 11-113097.

### SUMMARY OF THE INVENTION

However, in the method for calculating a sum signal indicating the sum of the left-channel sound signal and the right-channel sound signal and a difference signal indicating the difference between the left-channel sound signal and the right-channel sound signal and for separating a signal corresponding to center sound from a signal corresponding to background sound, which is sound other than the center sound, a signal of background sound acquired as a difference signal is a monaural signal, and the phase of the left-channel sound signal is opposite to the phase of the right-channel sound signal. Thus, such background sound is non-stereo sound.

It is desirable to provide a signal processing apparatus and a signal processing method that separately extract, from two-channel stereo signals, a high-quality center sound signal and a stereo background sound signal.

A signal processing apparatus according to an embodiment of the present invention includes first band-dividing means for dividing a first-channel sound signal of two-channel sound signals into signals of a plurality of frequency bands; second band-dividing means for dividing a second-channel sound signal of the two-channel sound signals into signals of a plurality of frequency bands; a plurality of main-component extracting means for each receiving, from among the signals of the plurality of frequency bands output from the first band-dividing means and the signals of the plurality of frequency bands output from the second band-dividing means, signals of the same frequency band, each of the plurality of main-component extracting means being provided in association with a corresponding frequency band; and synthesizing means for synthesizing a plurality of outputs acquired from the plurality of main-component extracting means to generate a main signal. Each of the plurality of main-component extracting means includes adding means for adding the signals of the same frequency band, first phase difference detecting means for detecting a phase difference between the signals of the same frequency band, gain generating means for outputting a gain corresponding to the phase difference detected by the first phase difference detecting means, and multiplying means for multiplying the gain generated by the gain generating means by an addition result output from the adding means and for outputting a multiplication result as an output of the main-component extracting means to the synthesizing means.

With this arrangement, each of the first-channel (left-channel) sound signal and the second-channel (right-channel) sound signal is divided into complex signals of a plurality of frequency bands. In the left and right channels, the phase difference between divided complex signals of the same frequency band is detected, and the detected phase difference is supplied to the gain generating means. Then, a gain corresponding to the phase difference is output.

In this case, in the gain generating means, the relationship between the input phase difference and the output gain has a characteristic in which the gain exhibits a value of 1.0 or a value close to 1.0 when the phase difference is 0 degrees, in which the gain exhibits a value of 0.0 or a value close to 0.0 when the phase difference is ±180 degrees, and in which the gain gradually decreases linearly when the phase difference changes from 0 degrees toward ±180 degrees.

The gain generated for each frequency band by the gain generated means is multiplied by an addition output signal acquired by adding complex signals of the frequency band acquired from the left and right channels. Multiplication results of all the frequency bands are synthesized together.

As a synthesized output, a signal of a component near a center localization position can be extracted. In addition, the signal of the component near the center localization position acquired from the synthesizing means is subtracted from each of the left-channel sound signal and the right-channel sound signal. Thus, left-channel and right-channel sound signals in which component near the center localization position can be generated.

Accordingly, instead of extracting, as a center sound component, only a signal component having a phase difference between a left-channel complex signal and a right-channel complex signal within a range between 0 degrees and a predetermined angle near 0 degrees, a center sound component is extracted using a gain having a characteristic in which the gain gradually decreases linearly when the phase difference changes from 0 degrees toward ±180 degrees. Thus, more natural and smooth center sound and stereo background sound can be separately extracted by using a relatively small number of divided frequency bands.

A signal processing apparatus according to another embodiment of the present invention includes first band-dividing means for dividing a first-channel sound signal of two-channel sound signals into signals of a plurality of frequency bands; second band-dividing means for dividing a second-channel sound signal of the two-channel sound signals into signals of a plurality of frequency bands; a plurality of sub-component extracting means for each receiving, from among the signals of the plurality of frequency bands output from the first band-dividing means and the signals of the plurality of frequency bands output from the second band-dividing means, signals of the same frequency band, each of the plurality of sub-component extracting means being provided in association with a corresponding frequency band; first synthesizing means for synthesizing a plurality of first-channel sub-component outputs acquired from the plurality of sub-component extracting means to generate a first-channel sub-signal; and second synthesizing means for synthesizing a plurality of second-channel sub-component outputs acquired from the plurality of sub-component extracting means to generate a second-channel sub-signal. Each of the plurality of sub-component extracting means includes phase difference detecting means for detecting a phase difference between the signals of the same frequency band, gain generating means for outputting a gain corresponding to the phase difference detected by the phase difference detecting means, first multiplying means for multiplying the gain generated by the gain generating means by a corresponding signal received from the first band-dividing means and for outputting a multiplication result as a sub-component output to the first synthesizing means, and second multiplying means for multiplying the gain generated by the gain generating means by a corresponding signal received from the second band-dividing means and for outputting a multiplication result as a sub-component output to the second synthesizing means.

With this arrangement, each of the first-channel (left-channel) sound signal and the second-channel (right-channel) sound signal is divided into complex signals of a plurality of frequency bands. In the left and right channels, the phase difference between divided complex signals of the same frequency band is detected, and the detected phase difference is supplied to the gain generating means. Then, a gain corresponding to the phase difference is output.

In this case, in the gain generating means, the relationship between the input phase difference and the output gain has a characteristic in which the gain exhibits a value of 0.0 or a value close to 0.0 when the phase difference is 0 degrees, in which the gain exhibits a value of 1.0 or a value close to 1.0 when the phase difference is 180 degrees, and in which the gain gradually increases linearly when the phase difference changes from 0 degrees toward ±180 degrees.

The gain generated for each frequency band generated by the gain generating means is multiplied by a left-channel complex signal of the frequency band. An acquired plurality of multiplication outputs are synthesized together, and a left-channel background sound component output is acquired. The gain generated for each frequency band generated by the gain generating means is multiplied by a right-channel complex signal of the frequency band. An acquired plurality of multiplication outputs are synthesized together, and a right-channel background sound component output is acquired.

In addition, a signal acquired by subtracting the left-channel background sound component output from the left-channel sound signal is added to a signal acquired by subtracting the right-channel background sound component output from the right-channel sound signal to generate a sound signal of a component near the center localization position.

Accordingly, instead of eliminating, as a center sound component, only a signal component having a phase difference between a left-channel complex signal and a right-channel complex signal within a range between 0 degrees and a predetermined angle near 0 degrees for each of a plurality of frequency bands, a center sound component is eliminated using a gain having a characteristic in which the gain gradually increases linearly when the phase difference changes from 0 degrees toward ±180 degrees. Thus, more natural and smooth center sound and stereo background sound can be separately extracted by using a relatively small number of divided frequency bands.

### BRIEF DESCRIPTION OF THE DRAWINGS

FIG. 1 is a block diagram showing a stereo signal processing apparatus according to a first embodiment of the present invention;

FIG. 2 is an illustration used for explaining an operation of a main portion of stereo signal processing apparatuses according to embodiments of the present invention;

FIG. 3 is an illustration used for explaining an operation of a main portion of the stereo signal processing apparatus according to the first embodiment;

FIGS. 4A and 4B are illustrations for explaining characteristics of a center sound signal and a background sound signal separately extracted by the stereo signal processing apparatuses according to the embodiments of the present invention;

FIG. 5 is a block diagram showing a stereo signal processing apparatus according to a second embodiment of the present invention; and

FIG. 6 is an illustration used for explaining an operation of a main portion of the stereo signal processing apparatus according to the second embodiment.

### DESCRIPTION OF THE PREFERRED EMBODIMENTS

A signal processing apparatus and a signal processing method according to embodiments of the present invention will be described with reference to the drawings.

### First Embodiment

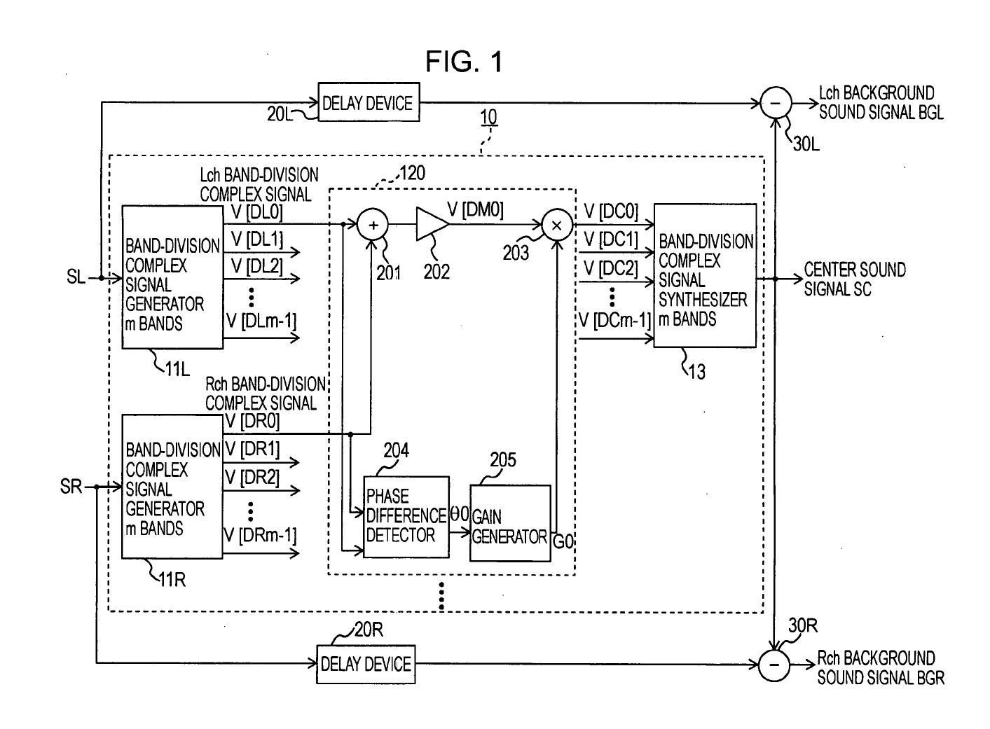

FIG. 1 is a block diagram showing a stereo signal processing apparatus according a first embodiment of the present invention. In the first embodiment, a center sound signal is extracted from a left-channel sound signal and a right-channel sound signal, and a left-channel background sound signal and a right-channel background sound signal are acquired by subtracting the extracted center sound signal from the left-channel sound signal and the right-channel sound signal, respectively.

As shown in FIG. 1, the stereo signal processing apparatus according to the first embodiment includes a center sound signal generator 10, a delay device 20L that delays a left-channel sound signal SL by the delay time of processing of the center sound signal generator 10, a delay device 20R that delays a right-channel sound signal SR by the delay time of processing of the center sound signal generator 10, a subtracter 30L that subtracts a center sound signal output from the center sound signal generator 10 from the left-channel sound signal SL that has been subjected to the processing of the delay device 20L, and a subtracter 30R that subtracts the center sound signal output from the center sound signal generator 10 from the right-channel sound signal SR that has been subjected to the processing of the delay device 20R.

The center sound signal generator 10 includes a band-division complex signal generator 11L for the left channel, a band-division complex signal generator 11R for the right channel, center sound component extractors 120, 121, 122, . . . , and 12m-1 (in FIG. 1, only the center sound component extractor 120 is shown, and the other center sound component extractors are not shown), and a band-division complex signal synthesizer 13. The number of center sound component extractors 120, 121, 122, . . . , and 12m-1 is equal to the number m (m is an integer of two or more) of divided bands in each of the band-division complex signal generator 11L for the left channel and the band-division complex signal generator 11R for the right channel.

As stereo sound, left-channel and right-channel sound signals at the center localization position and at a position near the center localization position have frequency components different from each other. From among left-channel and right-channel stereo sound signals, the left-channel sound signal SL is supplied to the band-division complex signal generator 11L for the left channel, and the right-channel sound signal SR is supplied to the band-division complex signal generator 11R for the right channel.

The band-division complex signal generators 11L and 11R convert the left-channel sound signal SL and the right-channel sound signal SR into complex signals V[DLi] and V[DRi] (i=0, 1, 2, . . . , and m-1) of m frequency bands, respectively. In this specification, a signal within “[ ]” of “V[ ]” is a vector signal (complex signal).

Each of the band-division complex signal generators 11L and 11R is formed, for example, by a discrete Fourier transform (DFT) filter bank.

DFT filter banks are explained in detail, for example, in Japanese Unexamined Patent Application Publication No. 8-248070 and “TECH I Shimyureishon de Manabu Dejitaru Shingou Shori, MATLAB ni yoru Reidai wo Tsukatte Mi ni Tsukeru Kiso kara Ouyou (Learning of TECH I Digital Signal Processing from Simulation, Learning of Applications From Basics using Examples of MATLAB)”, Vol. 9, p 158-p 163, written by Hiroshi Ochi, published by CQ Publishing Co., Ltd. Thus, detailed explanations will be omitted.

Complex signals V[DLi] and V[DRi] of the same frequency band output from the band-division complex signal generators 11L and 11R are supplied to the center sound component extractor 12i for the corresponding frequency band. FIG. 1 shows a case where complex signals V[DL0] and V[DR0] output from the band-division complex signal generators 11L and 11R are supplied to the center sound component extractor 120 for the corresponding frequency band.

Referring to FIG. 1, each of the center sound component extractors 120, 121, 122, . . . , and 12m-1 includes an adder 201, a gain adjustment amplifier 202, a multiplier 203, a phase difference detector 204, and a gain generator 205. Each of the center sound component extractors 120, 121, 122, . . . , and 12m-1 extracts a center sound component of a corresponding frequency band from the left-channel sound signal SL and the right-channel sound signal SR of the corresponding frequency band.

A center sound signal is a monaural signal, which is acquired by adding and averaging left-channel and right-channel signals and which includes all the components of the center sound signal. In this example, in the center sound component extractor 12i, the adder 201 adds complex signals V[DLi] and V[DRi] of the same frequency band acquired from the left and right channels, and the gain adjustment amplifier 202 averages the complex signals V[DLi] and V[DRi] to obtain a complex signal V[DMi] (=(V[DLi]+V[DRi]/2). The averaged complex signal V[DMi] is supplied to the multiplier 203.

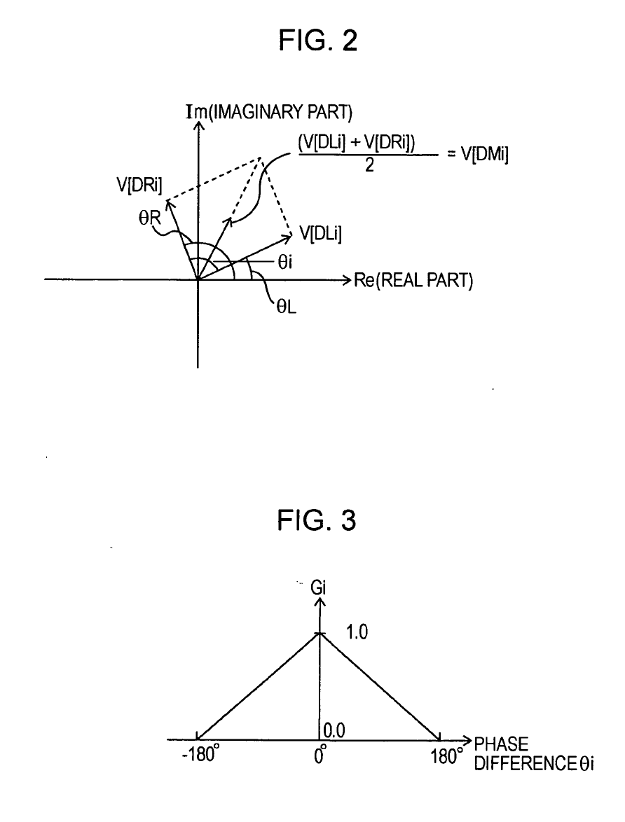

FIG. 2 is a vector diagram showing an example of a left-channel band-division complex signal V[DLi] and a right-channel band-division complex signal V[DRi]. An averaged complex signal V[DMi] is as illustrated in FIG. 2.

The band-division complex signal V[DLi] and the band-division complex signal V[DRI] of the same frequency band acquired from the left and right channels are also supplied to the phase difference detector 204, and the phase difference θi between the band-division complex signal V[DLi] and the band-division complex signal V[DRi] is calculated. That is, referring to the vector diagram of FIG. 2 showing band-division complex signals, the phase difference θi is equal to the difference between the phase angle of the band-division complex signal V[DLi] and the phase angle of the band-division complex signal V[DRi]. When “θL” represents the phase angle of the band-division complex signal V[DLi] and “OR” represents the phase angle of the band-division complex signal V[DRi], the phase difference θi is calculated by the equation θi=θL−θR or the equation θi=θR−θL.

As described above, the phase difference θi calculated by the phase difference detector 204 is supplied to the gain generator 205. The gain generator 205 outputs a gain Gi corresponding to the input phase difference θi. FIG. 3 shows an example of the relationship between an input phase difference and an output gain of the gain generator 205 in the first embodiment.

That is, in the example shown in FIG. 3, concerning a signal localized at the center, the phase of a signal component of a left-channel sound signal SL is equal to the phase of a signal component of a right-channel sound signal SR. Thus, when the phase difference θi is 0 degrees, the gain Gi exhibits a value of 1.0. When the phase difference θi is ±180 degrees, since the localization position of the signal is very far from the center, the gain Gi exhibits a value of 0.0.

A signal closer to the center localization position has a smaller phase difference θi. Thus, in the first embodiment, in a case where the phase difference θi is within a range between 0 and ±180 degrees, when the phase difference changes from 0 degrees toward ±180 degrees, the relationship between the input phase difference and the output gain of the gain generator 205 has a characteristic in which the output gain Gi linearly decreases gradually in a continuous fashion in accordance with the input phase difference θi.

In the example shown in FIG. 3, the relationship between the input phase difference and the output gain of the gain generator 205 has a characteristic in which, when the phase difference θi changes from 0 degrees toward ±180 degrees, the gain Gi linearly decreases from 1.0 to 0.0.

As described above, the center sound signal is a monaural signal. Thus, a complex signal V[DMi] acquired by adding and averaging a left-channel complex signal and a right-channel complex signal and supplied from the gain adjustment amplifier 202 includes the entire center sound signal. However, at the same time, the complex signal V[DMi] also includes signal components spread over left and right positions.

In the first embodiment, the signal V[DMi] acquired by vector addition and averaging is multiplied by the gain Gi generated in accordance with the phase difference between the left-channel signal and the right-channel signal. Thus, a complex signal V[DCi] of a component localized at a position near the center is extracted.

The above-described center sound component extraction processing is performed for m frequency bands by the m center sound component extractors 120, 121, 122, . . . , and 12m-1 provided corresponding to the m frequency bands.

Complex signals V[DC0], V[DC1], V[DC2], . . . , and V[DCm-1] of components localized at a position near the center are supplied from the center sound component extractors 120, 121, 122, . . . , and 12m-1 to the band-division complex signal synthesizer 13. The band-division complex signal synthesizer 13 synthesizes the components of all the frequency bands, and outputs a monaural signal localized at a position near the center, that is, a center sound signal SC, separately extracted from two-channel stereo signals.

A background sound component is included in each of a left-channel sound signal SL and a right-channel sound signal SR. A center sound component is also included in each of the left-channel sound signal SL and the right-channel sound signal SR.

In the first embodiment, the left-channel sound signal SL that has been subjected to processing of the delay device 20L is supplied to the subtracter 30L, and the center sound signal SC is also supplied to the subtracter 30L. The subtracter 30L subtracts the center sound signal SC from the left-channel sound signal SL to obtain a left-channel background sound signal BGL.

In addition, the right-channel sound signal SR that has been subjected to processing of the delay device 20R is supplied to the subtracter 30R, and the center sound signal SC is also supplied to the subtracter 30R. The subtracter 30R subtracts the center sound signal SC from the right-channel sound signal SR to obtain a right-channel background sound signal BGR.

The delay devices 20L and 20R are provided in order to compensate for a signal delay due to signal processing performed by the center sound signal generator 10. However, if the signal delay does not cause a practical problem, the delay devices 20L and 20R may be omitted.

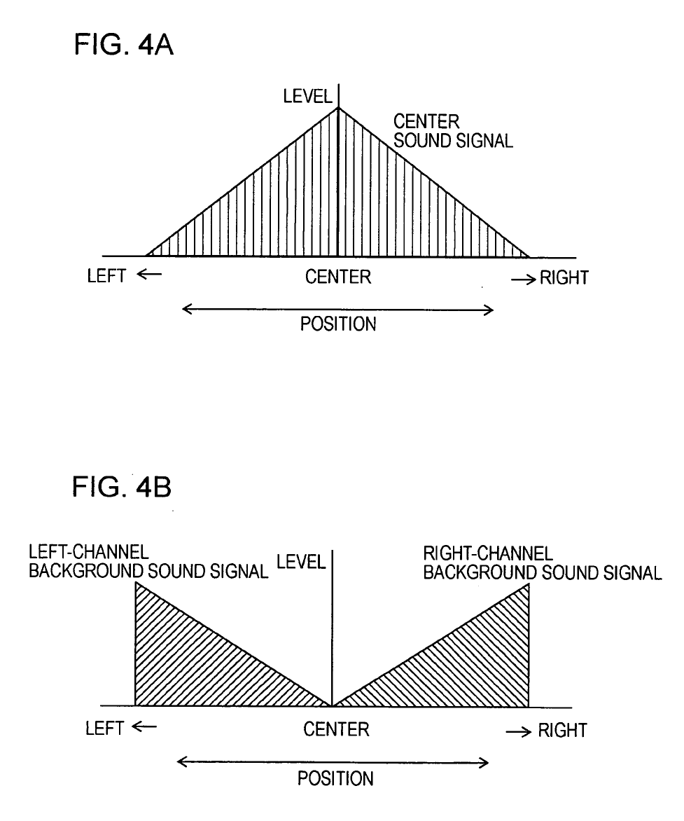

FIGS. 4A and 4B show regions of sound images separately extracted from input two-channel stereo signals. FIG. 4A shows a region of a sound image of a center sound signal, and FIG. 4B shows a region of a sound image of a background sound signal. As shown in FIG. 4B, the background sound is stereo background sound that is separated into a left-channel side and a right-channel side.

As described above, according to the first embodiment, with a relatively small number m of divided frequency bands, more natural and smooth center sound with high quality and stereo background sound can be separately extracted.

In a case where center sound is extracted from stereo sound signals, when the phase difference between a left-channel stereo sound signal that has been subjected to frequency band division and a right-channel stereo sound signal that has been subjected to frequency band division is detected and the center sound is extracted in accordance with the phase difference, a procedure for extracting only center sound having a phase difference close to 0 degrees is normally adopted. This is because the center sound is input such that the phase of a left channel signal is equal to the phase of a right channel signal.

Thus, basically, by extracting only a signal having a phase difference close to 0 degrees from left-channel and right-channel signals, center sound can be effectively separated. However, when only a signal having a phase difference close to 0 degrees is extracted from left-channel and right-channel signals, since signal components near the boundary of extraction are not fixed in a region of the center sound signal or a region of a background sound signal, unstable sound is obtained. Thus, in order to acquire an excellent sound quality as center sound or background sound, a large number of divided frequency bands, such as thousands of divided bands, should be used.

In the first embodiment, however, a signal component having a phase difference between a left-channel signal and a right-channel signal of a range between 0 degrees and a predetermined angle close to 0 degrees is not extracted from two-channel stereo sound signals. In the first embodiment, the relationship between the input phase difference and the output gain of the gain generator 205 has a characteristic in which, when the phase difference θi changes from 0 degrees toward ±180 degrees, the output gain Gi linearly decreases gradually in a continuous fashion in accordance with the input phase difference θi. Thus, since the boundary between a region of a center sound signal and a region of a background sound signal is not abrupt, more natural and smooth center sound and stereo background sound can be separately extracted by using a relatively smaller number m of divided bands.

### Second Embodiment

In the first embodiment, a center sound signal SC is extracted from two-channel stereo signals, and a left-channel background sound signal BGL and a right-channel background sound signal BGR are acquired by subtracting the center sound signal SC from the left-channel sound signal SL and the right-channel sound signal SR.

In a second embodiment, however, a left-channel background sound signal BGL and a right-channel background sound signal BGR are extracted from two-channel stereo signals, and a center sound signal SC is acquired by subtracting the left-channel background sound signal BGL and the right-channel background sound signal BGR from a left-channel sound signal SL and a right-channel sound signal SR.

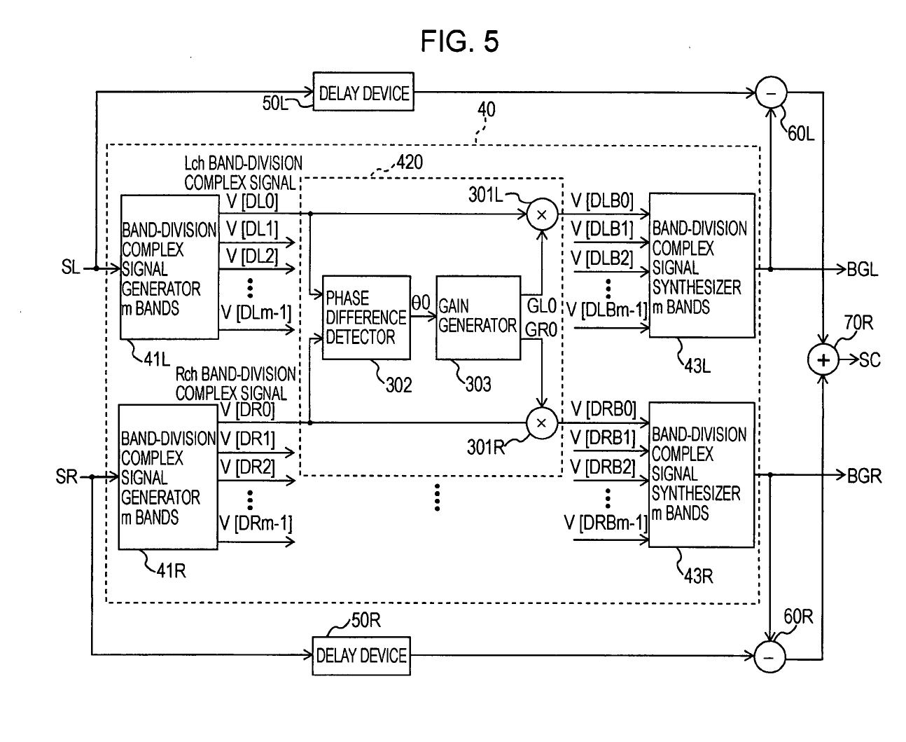

As shown in FIG. 5, a stereo signal processing apparatus according to the second embodiment includes a background sound signal generator 40, a delay device SOL that delays a left-channel sound signal SL by the delay time of processing of the background sound signal generator 40, a delay device 50R that delays a right-channel sound signal SR by the delay time of processing of the background sound signal generator 40, a subtracter 60L that subtracts a background sound signal output from the background sound signal generator 40 from the left-channel sound signal SL that has been subjected to the processing of the delay device SOL, a subtracter 60R that subtracts a background sound signal output from the background sound signal generator 40 from the right-channel sound signal SR that has been subjected to the processing of the delay device 50R, and an adder 70 that adds an output of the subtracter 60L and an output of the subtracter 60R.

The background sound signal generator 40 includes a band-division complex signal generator 41L for the left channel, a band-division complex signal generator 41R for the right channel, background sound component extractors 420, 421, 422, . . . , and 42m-1 (in FIG. 5, only the background sound component extractor 420 is shown, and the other background sound component extractors are not shown), a band-division complex signal synthesizer 43L for the left channel, and a band-division complex signal synthesizer 43R for the right channel. The number of background sound component extractors 420, 421, 422, . . . , and 42m-1 is equal to the number m (m is an integer of two or more) of divided bands in each of the band-division complex signal generators 41L and 41R.

The band-division complex signal generators 41L and 41R used in the second embodiment have configurations completely similar to those of the band-division complex signal generators 11L and 11R used in the first embodiment. Thus, as in the first embodiment, the band-division complex signal generators 41L and 41R convert the left-channel sound signal SL and the right-channel sound signal SR into complex signals V[DLi] and V[DRi] of m frequency bands.

Complex signals V[DLi] and V[DRi] of the same frequency band output from the band-division complex signal generators 41L and 41R are supplied to the background sound component extractor 42i for the corresponding frequency band. FIG. 5 shows a case where complex signals V[DL0] and V[DR0] output from the band-division complex signal generators 41L and 41R are supplied to the background sound component extractor 420 for the corresponding frequency band.

Referring to FIG. 5, each of the background sound component extractors 420, 421, 422, . . . , and 42m-1 includes multipliers 301L and 301R, a phase difference detector 302, and a gain generator 303. Each of the background sound component extractors 420, 421, 422, . . . , and 42m-1 extracts left-channel and right-channel background sound components of a corresponding frequency band from the left-channel and right-channel sound signals SL and SR of the corresponding frequency band.

In this example, in the background sound component extractor 42i, a complex signal V[DLi] and a complex signal V[DRi] of the same frequency band acquired from the left and right channels are supplied to the multipliers 30L and 301R, respectively.

The complex signals V[DLi] and V[DRi] of the same frequency band acquired from the left and right channels are also supplied to the phase difference detector 302 to calculate the phase difference θi between the complex signals V[DLi] and V[DRi], as in the first embodiment.

The phase difference θi calculated by the phase difference detector 302 is supplied to the gain generator 303. The gain generator 303 outputs a left-channel gain GLi and a right-channel gain GRi corresponding to the input phase difference θi. For example, in FIG. 2, when the phase difference θi is acquired by the equation θi=θL−θR, the gain generator 303 outputs a gain GLi. In contrast, when the phase difference θi is acquired by the equation θi=θR−θL, the gain generator 303 outputs a gain GRi.

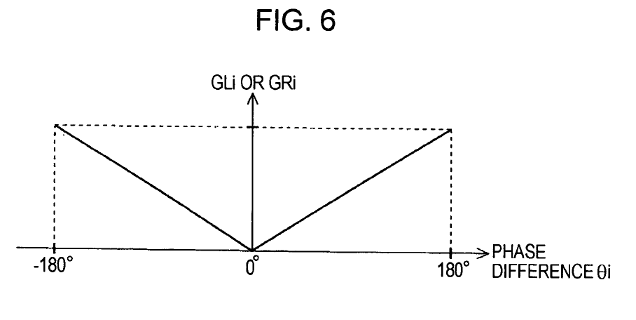

FIG. 6 shows an example of the relationship between the input phase difference and the output gain of the gain generator 303 in the second embodiment.

That is, in the example shown in FIG. 6, concerning a signal localized at the center, the phase of a signal component of a left-channel sound signal SL is equal to the phase of a signal component of a right-channel sound signal SR. Thus, for suppression, when the phase difference θi is 0 degrees, each of the gains GLi and GRi exhibits a value of 0.0. In addition, when the phase difference θi is ±180 degrees, the signal is localized at a position very far from the center, that is, the signal indicates background sound. Thus, each of the gains GLi and GRi exhibits a value of 1.0.

In the second embodiment, in a case where the phase difference θi is within a range between 0 degrees and ±180 degrees, when the phase difference changes from 0 degrees toward ±180 degrees, the relationship between the input phase difference and the output gain of the gain generator 303 has a characteristic in which the output gain Gi linearly increases gradually in a continuous fashion in accordance with the input phase difference θi.

In the example shown in FIG. 6, the relationship between the input phase difference and the output gain of the gain generator 303 has a characteristic in which, when the phase difference changes from 0 degrees toward ±180 degrees, each of the gains GLi and GRi linearly increases from 0.0 to 1.0.

The multiplier 301L multiplies the left-channel gain GLi acquired as described above by a complex signal V[DLi] of a corresponding frequency band supplied from the band-division complex signal generator 41L, and a left-channel background sound component complex signal V[DLBi] of the frequency band is extracted.

In addition, the multiplier 301R multiplies the right-channel gain GRi acquired as described above by a complex signal V[DRi] of a corresponding frequency band supplied from the band-division complex signal generator 41R, and a right-channel background sound component complex signal V[DRBi] of the frequency band is extracted.

The above-described background sound component extraction processing is performed for m frequency bands by the m background sound component extractors 420, 421, 422, . . . , and 42m-1 provided corresponding to the m frequency bands.

Left-channel background sound component complex signals V[DLB0], V[DLB1], V[DLB2], . . . , and V[DLBm-1] output from the m background sound component extractors 420, 421, 422, . . . , and 42m-1 are supplied to the band-division complex signal synthesizer 43L for the left channel. The band-division complex signal synthesizer 43L for the left channel synthesizes the components of all the frequency bands, and outputs a left-channel background sound signal BGL, which is separated from the left-channel sound signal SL.

Right-channel background sound component complex signals V[DRB0], V[DRB1], V[DRB2], . . . , and V[DRBm-1] output from the m background sound component extractors 420, 421, 422, . . . , and 42m-1 are supplied to the band-division complex signal synthesizer 43R for the right channel. The band-division complex signal synthesizer 43R for the right channel synthesizes the components of all the frequency bands, and outputs a right-channel background sound signal BGR, which is separated from the right-channel sound signal SR.

In the second embodiment, the left-channel sound signal SL that has been subjected to processing of the delay device 50L and the left-channel background sound signal BGL are supplied to the subtracter 60L. The subtracter 60L subtracts the left-channel background sound signal BGL from the left-channel sound signal SL, and outputs a center sound signal SCL included in the left-channel sound signal SL.

In addition, the right-channel sound signal SR that has been subjected to processing of the delay device 50R and the right-channel background sound signal BGR are supplied to the subtracter 60R. The subtracter 60R subtracts the right-channel background sound signal BGR from the right-channel sound signal SR, and outputs a center sound signal SCR included in the right-channel sound signal SR.

Then, the center sound signal SCL included in the left-channel sound signal SL supplied from the subtracter 60L and the center sound signal SCR included in the right-channel sound signal SR supplied from the subtracter 60R are supplied to the adder 70. The adder 70 adds the center sound signal SCL and the center sound signal SCR, and outputs a center sound signal SC.

In the second embodiment, more natural and smooth center sound and stereo background sound can be separately extracted by using a relatively small number of divided frequency bands, as in the first embodiment.

### Other Embodiments and Modifications

In the first embodiment, left-channel and right-channel background sound signals are generated by extracting a center sound signal from two-channel stereo signals and by subtracting the center sound signal from each of the left-channel and right-channel signals. However, instead of acquiring a background sound signal by subtracting a center sound signal from each of left-channel and right-channel signals, a background sound signal may be generated by the processing of the background sound signal generator 40, as in the second embodiment. In this case, left-channel and right-channel band-division complex signal generators and a phase difference detector can be shared between a center sound signal generator and a background sound signal generator.

In addition, the phase difference θi is directly calculated from the phase angles OL and OR of the complex signals V[DLi] and V[DRi] in the first and second embodiments. However, the phase difference θi may be calculated by other methods. For example, in the vector diagram of FIG. 2, the angel θi formed by vectors may be calculated from the inner product and the norm of the complex signals V[DLi] and V[DRi]. Alternatively, the phase difference θi may be indirectly calculated from the amplitude ratio of the complex signal V[DLi] to the averaged complex signal V[DMi]. That is, when the amplitude ratio is 1, the phase difference θi is 0 degrees. When the amplitude ratio is 0, the phase difference θi is +90 degrees. When the amplitude ratio is −1, the phase difference θi is ±180 degrees. Thus, for example, the horizontal axis of FIG. 3 may be replaced with the amplitude ratio.

In the gain generator 205 used in the first embodiment, when the phase difference θi is 0 degrees, the gain Gi exhibits a value of 1.0. However, the gain Gi does not necessarily exhibit a value of 1.0 precisely. The gain Gi may exhibit a value near 1.0. Similarly, in the gain generator 205 used in the first-embodiment, when the phase difference θi is +180 degrees, the gain Gi exhibits a value of 0.0. However, the gain Gi does not necessarily exhibit a value of 0.0 precisely. The gain Gi may exhibit a value near 0.0. The same applies to the gain generator 303 used in the second embodiment.

In addition, a gain function used in each of the gain generators 205 and 303 has a characteristic in which the gain changes linearly. However, the gain function does not necessarily have a linear change characteristic. Other gain functions may be used as long as the gain decreases or increases gradually in a continuous fashion in accordance with a linear change.

However, the inventor of the present invention confirms that a center sound signal with the highest quality and the most excellent stereo background sound signal can be acquired when the gain changes linearly.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus comprising:
first band-dividing means for dividing a first-channel sound signal of two-channel sound signals into signals of a plurality of frequency bands;
second band-dividing means for dividing a second-channel sound signal of the two-channel sound signals into signals of a plurality of frequency bands;
a plurality of main-component extracting means for each receiving, from among the signals of the plurality of frequency bands output from the first band-dividing means and the signals of the plurality of frequency bands output from the second band-dividing means, signals of the same frequency band, each of the plurality of main-component extracting means being provided in association with a corresponding frequency band; and
synthesizing means for synthesizing a plurality of outputs acquired from the plurality of main-component extracting means to generate a main signal,
wherein each of the plurality of main-component extracting means includes
adding means for adding the signals of the same frequency band,
first phase difference detecting means for detecting a phase difference between the signals of the same frequency band,
gain generating means for outputting a gain corresponding to the phase difference detected by the first phase difference detecting means, and
multiplying means for multiplying the gain generated by the gain generating means by an addition result output from the adding means and for outputting a multiplication result as an output of the main-component extracting means to the synthesizing means.

2. The signal processing apparatus according to claim 1, wherein the gain generating means outputs the gain having a characteristic in which the gain exhibits a value of 1.0 or a value close to 1.0 when the phase difference detected by the first phase difference detecting means is 0 degrees, in which the gain exhibits a value of 0.0 or a value close to 0.0 when the phase difference is ±180 degrees, and in which the gain gradually decreases linearly when the phase difference changes from 0 degrees toward ±180 degrees.

3. The signal processing apparatus according to claim 1, further comprising:
first subtracting means for subtracting the main signal output from the synthesizing means from the first-channel sound signal to generate a first-channel residual signal; and
second subtracting means for subtracting the main signal output from the synthesizing means from the second-channel sound signal to generate a second-channel residual signal.

4. The signal processing apparatus according to claim 1, further comprising:
a plurality of sub-component extracting means for each receiving, from among the signals of the plurality of frequency bands output from the first band-dividing means and the signals of the plurality of frequency bands output from the second band-dividing means, signals of the same frequency band, each of the plurality of sub-component extracting means being provided in association with a corresponding frequency band;
first sub-signal synthesizing means for synthesizing a plurality of first-channel sub-component outputs acquired from the plurality of sub-component extracting means to generate a first-channel sub-signal; and
second sub-signal synthesizing means for synthesizing a plurality of second-channel sub-component outputs acquired from the plurality of sub-component extracting means to generate a second-channel sub-signal,
wherein each of the plurality of sub-component extracting means includes
second phase difference detecting means for detecting a phase difference between the signals of the same frequency band,
second gain generating means for outputting a gain corresponding to the phase difference detected by the second phase difference detecting means,
first multiplying means for multiplying the gain generated by the second gain generating means by a corresponding signal received from the first band-dividing means and for outputting a multiplication result as a sub-component output to the first sub-signal synthesizing means, and
second multiplying means for multiplying the gain generated by the second gain generating means by a corresponding signal received from the second band-dividing means and for outputting a multiplication result as a sub-component output to the second sub-signal synthesizing means.

5. The signal processing apparatus according to claim 4, wherein the second gain generating means outputs the gain having a characteristic in which the gain exhibits a value of 0.0 or a value close to 0.0 when the phase difference detected by the second phase difference detecting means is 0 degrees, in which the gain exhibits a value of 1.0 or a value close to 1.0 when the phase difference is ±180 degrees, and in which the gain gradually increases linearly when the phase difference changes from 0 degrees toward ±180 degrees.

6. The signal processing apparatus according to claim 4, wherein the first phase detecting means and the second phase detecting means are integrated with each other.

7. A signal processing apparatus comprising:
first band-dividing means for dividing a first-channel sound signal of two-channel sound signals into signals of a plurality of frequency bands;
second band-dividing means for dividing a second-channel sound signal of the two-channel sound signals into signals of a plurality of frequency bands;
a plurality of sub-component extracting means for each receiving, from among the signals of the plurality of frequency bands output from the first band-dividing means and the signals of the plurality of frequency bands output from the second band-dividing means, signals of the same frequency band, each of the plurality of sub-component extracting means being provided in association with a corresponding frequency band;
first synthesizing means for synthesizing a plurality of first-channel sub-component outputs acquired from the plurality of sub-component extracting means to generate a first-channel sub-signal; and
second synthesizing means for synthesizing a plurality of second-channel sub-component outputs acquired from the plurality of sub-component extracting means to generate a second-channel sub-signal,
wherein each of the plurality of sub-component extracting means includes
phase difference detecting means for detecting a phase difference between the signals of the same frequency band,
gain generating means for outputting a gain corresponding to the phase difference detected by the phase difference detecting means,
first multiplying means for multiplying the gain generated by the gain generating means by a corresponding signal received from the first band-dividing means and for outputting a multiplication result as a sub-component output to the first synthesizing means, and
second multiplying means for multiplying the gain generated by the gain generating means by a corresponding signal received from the second band-dividing means and for outputting a multiplication result as a sub-component output to the second synthesizing means.

8. The signal processing apparatus according to claim 7, further comprising subtracting means for subtracting the first-channel sub-signal received from the first synthesizing means and the second-channel sub-signal received from the second synthesizing means from a sum signal acquired by adding the first-channel sound signal and the second-channel sound signal to generate a main sound signal.

9. A signal processing method comprising the steps of:
dividing a first-channel sound signal of two-channel sound signals into signals of a plurality of frequency bands;
dividing a second-channel sound signal of the two-channel sound signals into signals of a plurality of frequency bands;
extracting, from signals of the same frequency band from among the signals of the plurality of frequency bands acquired from the first-channel sound signal and the signals of the plurality of frequency bands acquired from the second-channel sound signal, a main-component output of the two-channel sound signals; and
synthesizing acquired main component outputs of the plurality of frequency bands to generate a main signal,
wherein the extracting of the main-component output includes the steps of
adding the signals of the same frequency band acquired from the first channel and the second channel,
detecting a phase difference between the signals of the same frequency band acquired from the first channel and the second channel,
outputting a gain corresponding to the detected phase difference between the signals of the same frequency band, and
multiplying the generated gain corresponding to the phase difference between the signals of the same frequency band by an acquired addition result of the signals of the same frequency band and outputting a multiplication result as the output of the extracting of the main-component output.

10. A signal processing method comprising the steps of:
dividing a first-channel sound signal of two-channel sound signals into signals of a plurality of frequency bands;
dividing a second-channel sound signal of the two-channel sound signals into signals of a plurality of frequency bands;
extracting, from signals of the same frequency band from among the signals of the plurality of frequency bands acquired from the first-channel sound signal and the signals of the plurality of frequency bands acquired from the second-channel sound signal, a first-channel sub-component and a second-channel sub-component of the two-channel sound signals; and
synthesizing an acquired plurality of first-channel sub-component outputs to generate a first-channel sub-signal and synthesizing an acquired plurality of second-channel sub-component outputs to generate a second-channel sub-signal,
wherein the extracting of the first-channel sub-component and the second-channel sub-component includes the steps of
detecting a phase difference between the signals of the same frequency band acquired from the first channel and the second channel,
outputting a gain corresponding to the detected phase difference between the signals of the same frequency band,
multiplying the generated gain corresponding to the phase difference between the signals of the same frequency band by a corresponding signal of the same frequency band acquired from the first-channel sound signal and outputting a multiplication result as a first-channel sub-component output, and
multiplying the generated gain corresponding to the phase difference between the signals of the same frequency band by a corresponding signal of the same frequency band acquired from the second-channel sound signal and outputting a multiplication result as a second-channel sub-component output.

11. A signal processing apparatus comprising:
a first band-dividing unit that divides a first-channel sound signal of two-channel sound signals into signals of a plurality of frequency bands;
a second band-dividing unit that divides a second-channel sound signal of the two-channel sound signals into signals of a plurality of frequency bands;
a plurality of main-component extracting units that each receive, from among the signals of the plurality of frequency bands output from the first band-dividing unit and the signals of the plurality of frequency bands output from the second band-dividing unit, signals of the same frequency band, each of the plurality of main-component extracting units being provided in association with a corresponding frequency band; and
a synthesizing unit that synthesizes a plurality of outputs acquired from the plurality of main-component extracting units to generate a main signal,
wherein each of the plurality of main-component extracting units includes
an adder that adds the signals of the same frequency band,
a first phase difference detector that detects a phase difference between the signals of the same frequency band,
a gain generator that outputs a gain corresponding to the phase difference detected by the first phase difference detector, and
a multiplier that multiplies the gain generated by the gain generator by an addition result output from the adder and that outputs a multiplication result as an output of the main-component extracting unit to the synthesizing unit.

12. A signal processing apparatus comprising:
a first band-dividing unit that divides a first-channel sound signal of two-channel sound signals into signals of a plurality of frequency bands;
a second band-dividing unit that divides a second-channel sound signal of the two-channel sound signals into signals of a plurality of frequency bands;
a plurality of sub-component extracting units that each receive, from among the signals of the plurality of frequency bands output from the first band-dividing unit and the signals of the plurality of frequency bands output from the second band-dividing unit, signals of the same frequency band, each of the plurality of sub-component extracting units being provided in association with a corresponding frequency band;
a first synthesizing unit that synthesizes a plurality of first-channel sub-component outputs acquired from the plurality of sub-component extracting units to generate a first-channel sub-signal; and
a second synthesizing unit that synthesizes a plurality of second-channel sub-component outputs acquired from the plurality of sub-component extracting units to generate a second-channel sub-signal,
wherein each of the plurality of sub-component extracting units includes
a phase difference detector that detects a phase difference between the signals of the same frequency band,
a gain generator that outputs a gain corresponding to the phase difference detected by the phase difference detector,
a first multiplier that multiplies the gain generated by the gain generator by a corresponding signal received from the first band-dividing unit and that outputs a multiplication result as a sub-component output to the first synthesizing unit, and
a second multiplier that multiplies the gain generated by the gain generator by a corresponding signal received from the second band-dividing unit and that outputs a multiplication result as a sub-component output to the second synthesizing unit.
